(19) United States
(12) Patent Application Publication
(10) Pub. No.: US 2008/0044638 A1
(43) Pub. Date: Feb. 21, 2008

(54) Nanostructured Metal Oxides

(76) Inventor: Fred Ratel, Tucson, AZ (US)

Correspondence Address: SHEPPARD MULLIN RICHTER & HAMPTON LLP, 48th Floor, 333 South Hope Street, Los Angeles, CA, 90071, US

(21) Appl. No.: 11/681,721

(22) Filed: Mar. 2, 2007

Related U.S. Application Data
(60) Provisional application No. 60/778,729, filed on Mar. 2, 2006.
(60) Provisional application No. 60/778,730, filed on Mar. 2, 2006.
(60) Provisional application No. 60/811,314, filed on Jun. 5, 2006.
(60) Provisional application No. 60/811,315, filed on Jun. 5, 2006.

(51) Int. Cl. B32B 27/32; B05D 3/02; G11B 5/64

(52) U.S. Cl. 428/220; 427/314; 428/336

(57) ABSTRACT

The present invention generally relates to materials that may be used to construct photoelectrodes. It more specifically relates to nanostructured metal oxide materials that may be used in photoelectrodes. In a composition aspect, the present invention provides a metal oxide film. The film ranges in thickness from 20 nm to 200 nm. There are at least 10 individual structures on the film surface within a 0.25 μm² area.

### CROSS-REFERENCE TO RELATED APPLICATIONS

This application claims priority to U.S. Provisional Patent Application Ser. No. 60/778,729 filed on Mar. 2, 2006, U.S. Provisional Patent Application Ser. No. 60/778,730 filed on Mar. 2, 2006, U.S. Provisional Patent Application Ser. No. 60/811,314 filed on Jun. 5, 2006 and U.S. Provisional Patent Application Ser. No. 60/811,315 filed on Jun. 5, 2006 the entire disclosures of which are incorporated by reference.

### FIELD OF THE INVENTION

The present invention generally relates to materials that may be used to construct photoelectrodes. It more specifically relates to nanostructured metal oxide materials that may be used in photoelectrodes.

### BACKGROUND OF THE INVENTION

There is an interest among researchers directed to the splitting of water through the use of semiconducting photoelectrodes exposed to visible light. This interest has resulted in several journal reports, including the following: R. Asahi, T. Morikawa, T. Ohwaki, K. Aoki, Y. Taga, Science (Washington, D.C., United States) 293 (2001) 269; S. U. M. Khan, M. Al-Shahry, W. B. Ingler Jr., Science (Washington, D.C., United States) 297 (2002) 2243; and, C. Jorand Sartoretti, M. Ulmann, B. D. Alexander, J. Augustynski, A. Weidenkaff, J. Chemical Physics Letters 376 (2003) 194-200 (“Augustynski”).

Augustynski discusses photoelectrodes made from thin films of Fe₂O₃. The article reports that 0.01 to 0.05 M solutions of Fe(acetylacetonate)₃ in pure ethanol were subjected to spray pyrolysis. The procedure involved spraying the solution onto a conducting glass plate having a 0.5 μm thick F-doped SnO₂ overlayer at a temperature between 400 and 440° C. Spraying involved the use of nitrogen as a carrier gas at a flow rate of approximately 7.5 l/min. Augustynski labeled electrodes made by this procedure as “type A.” “Type C” electrodes discussed by Augustynski were made similarly to type A electrodes, except that 0.1 M solutions of FeCl₃.6H₂O were used instead of Fe(acetylacetonate)₃.

Augustynski reports that Raman microscopy was used to analyze the crystalline Fe₂O₃ phase present in thin films. The relevant text reads as follows: “Direct comparison with both literature data for iron oxide minerals and library spectra of pure iron oxide powders, recorded under the same conditions, shows that almost all of the bands in FIG. 2a can be readily assigned to hematite, α-Fe₂O₃. The sole exception is the broad band present at ca. 663 cm⁻¹ which can most likely be assigned to magnetite, Fe₃O₄.” p. 197, col. 2.

The Augustynski article further discusses the likely purity of the thin films: “Upon comparison of the relative intensities of the α-Fe₂O₃ band at 409 cm⁻¹ and the Fe₃O₄ band at 663 cm⁻¹ with the intensities of these bands in the library spectra, the composition of the Fe₂O₃ electrodes has been estimated to contain over 70% of α-Fe₂O₃.” p. 197, col. 2. In other words, Augustynski's best guess is that the material is approximately 70% α-Fe₂O₃.

Augustynski notes that “increasing the number of applied layers [of α-Fe₂O₃] above six [in an electrode] does not produce a substantial enhancement in the photocurrent.” p. 198, col. 1. The article reports that a six layer type A electrode is approximately 0.35 μm thick, while a six layer type C electrode is approximately 0.5 μm thick.

Despite reports such as Augustynski's, there remains a need in the art for improved metal oxide materials that may be used in a photoelectrode. That is an object of the present invention.

### BRIEF DESCRIPTION OF THE FIGURES

FIG. 1 shows a flow chart illustrating a general method of the present invention.

FIG. 2 shows a general ultrasonic spray pyrolysis apparatus used in a method of the present invention.

### SUMMARY OF THE INVENTION

The present invention generally relates to materials that may be used to construct photoelectrodes. It more specifically relates to nanostructured metal oxide materials that may be used in photoelectrodes.

In a composition aspect, the present invention provides a metal oxide film. The film ranges in thickness from 20 nm to 200 nm. There are typically at least 10 individual structures on the film surface within a 0.25 μm² area, and the individual structures typically have a ratio of long dimension to short being of at least 2:1. The thickness of the individual structures ranges from 0.25 nm to 6 nm, and the individual structures are oriented at an angle between 20° and 160° relative to the film surface plane.

In a method aspect, the present invention provides a method of producing a metal oxide film. The method includes the steps of: a) generating a micron-sized aerosol of an metal oxide precursor solution, wherein the precursor solution comprises a metal-based organometallic at a concentration ranging from 0.001M to 0.02 M in either an organic alcohol or ether; b) directing the aerosol to a heated substrate, wherein the substrate is either: a) spectrally transparent glass with a conductive overlayer, or, b) a spectrally transparent cyclic-olefin copolymer or poly(norbornene), and wherein the substrate temperature is less than 400° C.; and, c) allowing the metal oxide precursor to pyrolyze on the substrate surface thereby forming the metal oxide film.

In an article of manufacture aspect, the present invention provides a photo-anode. The photo-anode includes: a) a substrate, and, b) a metal oxide film. The substrate is either a) spectrally transparent glass with a conductive overlayer, or, b) a spectrally transparent cyclic-olefin copolymer or poly(norbornene). The film ranges in thickness from 20 nm to 200 nm. There are at typically least 10 individual structures on the film surface within a 0.25 μm² area, and the individual structures typically have a ratio of long dimension of at least 2:1. The thickness of individual structures typically ranges from 0.25 nm to 6 nm, and the individual structures are oriented at an angle between 20° and 160° relative to the film surface plane.

### DETAILED DESCRIPTION

The present invention generally relates to materials that may be used to construct photoelectrodes. It more specifically relates to nanostructured metal oxide materials that may be used in photoelectrodes.

Metal oxides prepared by the method of the present invention include, but are not limited to, the following: tungsten oxide; doped tungsten oxide; titanium oxide; doped titanium oxide; zinc oxide; doped zinc oxide; tin oxide; doped tin oxide; indium oxide; doped indium oxide; doped iron oxide; and, any other combination of doped transition metal and/or post transition metal oxide arising from Columns IIIB to IVA of the Periodic Table.

The nanostructured metal oxide materials are typically formed as films on a substrate. Film thickness usually ranges from 20 nm to 200 nm. Oftentimes, the film thickness ranges from 50 nm to 160 nm or 80 nm to 120 nm. In certain cases, the film thickness is approximately 100 nm.

The surface of films of the present metal oxide materials typically exhibit individual structures (e.g., disc-like structures, box-like structures, diamond-like structures, etc.). Such structures typically have a ratio of long dimension to short dimension of at least 2:1. Oftentimes the ratio is at least 3:1 or 4:1. In certain cases, the ratio is at least 5:1 or 6:1.

The thickness of the individual structures typically ranges from 0.25 nm to 6 nm. Oftentimes the thickness ranges from 0.38 nm to 5.5 nm, and in certain cases it ranges from 0.5 nm to 5.1 nm.

Individual structures of the present invention are typically oriented at an angle between 20° and 160° relative to the surface plane. Oftentimes, the structures are oriented at an angle between 40° and 140° or between 60° and 120° relative to the surface plane. In certain cases, the individual structures are oriented at a angle of approximately 90°.

Thin metal oxide films of the present invention typically contain at least 10 individual structures on their surface within a 0.25 μm² area. Oftentimes, the films contain at least 25 or 50 individual structures on their surface within a 0.25 μm² area. In certain cases, the films contain at least 75 or 100 individual structures on their surface within a 0.25 μm² area.

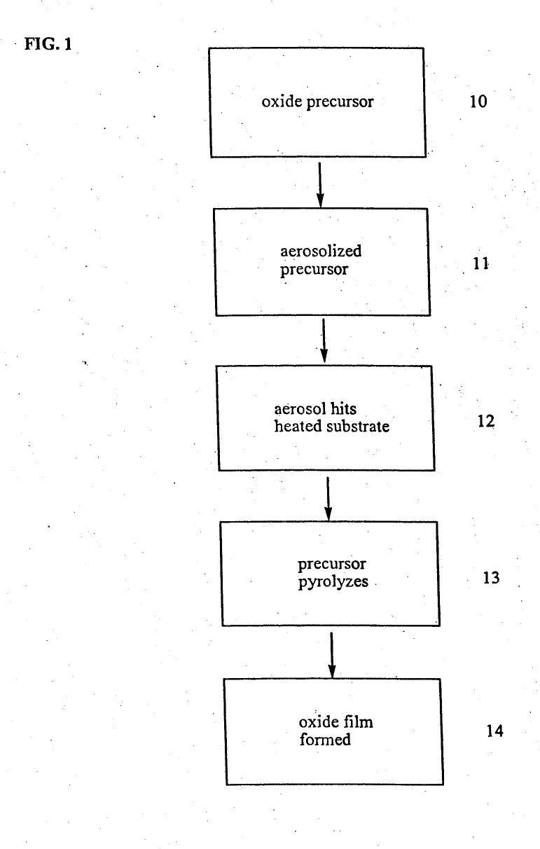

The metal oxide films are typically formed using an ultrasonic spray pyrolysis procedure, which is generally described in reference to FIG. 1. A metal oxide precursor solution (10) is aerosolized (11). The aerosol hits a heated substrate (12); the solvent is evaporated; and, the precursor pyrolyzes (13) to form the metal oxide film (14).

The metal oxide precursor solution (10) is typically a dilute solution of a metal-based organometallic dissolved in an organic solvent.

Nonlimiting examples of metal oxide precursors include pyrophoric organometallic precursors such as iron pentacarbonyl, diethylzinc, and dibutyltin diacetate. Other gaseous and/or liquid metal-containing precursors with a vapor pressure higher than water (e.g., tungsten hexafluoride) may also be used.

The organic solvent of the metal oxide precursor solution (10) is typically an organic alcohol or ether. Nonlimiting examples of organic alcohols include ethanol (e.g., 200 proof ethanol) and t-butanol. A nonlimiting example of an organic ether is tetrahydrofuran.

Metal oxide precursor solutions (10) of the present invention typically contain a concentration of an metal-based organometallic ranging from 0.001M to 0.02M. Oftentimes the concentration ranges from 0.003M to 0.015M, and in some cases it ranges from 0.005M to 0.011M, with 0.01M being common.

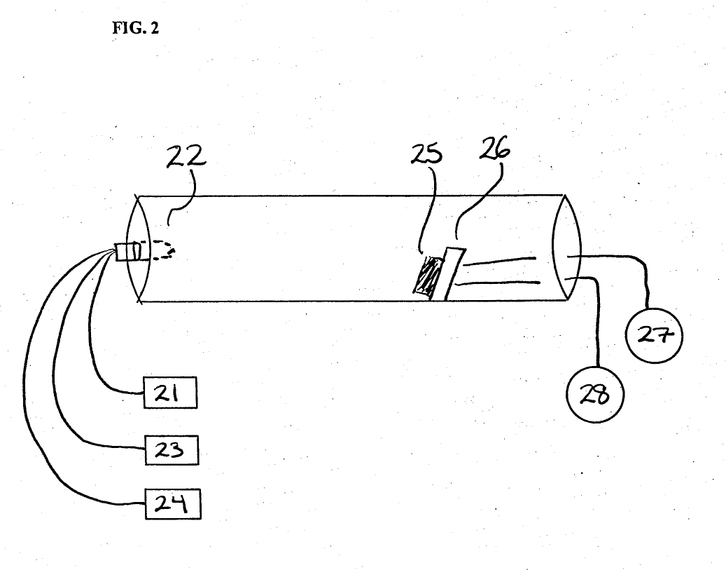

An ultrasonic spray pyrolysis apparatus is generally described in reference to FIG. 2. A metal oxide precursor solution is pumped by a liquid feed (23) through an ultrasonic generator, (21) which is connected to a USP nozzle (22). Carrier gas (24) is fed into the generator (21), combining with the metal oxide precursor solution, which emerges from the nozzle (22) as a micron-sized aerosol. The micron-sized aerosol hits a heated substrate (25) that is in contact with a platform (26), and the metal oxide precursor is pyrolyzed. Heat is provided to the substrate (25) through the platform (26), which is heated by a power source (28). The temperature of the platform (26) is controlled, and accordingly the temperature of the substrate (25), by a thermocouple (27).

Liquid feed (23) is typically a syringe pump utilizing a gas-tight syringe, but may be any suitable apparatus providing a constant, controllable flow of metal oxide precursor solution, and limiting the evaporation of the solvent. Liquid feed (23) usually pumps the solution at a rate ranging from 1.0 to 2.2 mL/min. Oftentimes, the solution is pumped at a rate of 1.3 to 1.9 mL/min, with 1.6 mL/min being common.

Carrier gas (24) typically flows at a rate ranging from 5.0 to 7.0 L/min. Oftentimes, the gas flows at a rate ranging from 5.5 to 6.5 L/min, with 6 L/min being common.

Nozzle (22) contains an opening through which the ultrasonically generated aerosol emerges (e.g., Lechler Model US-1 ultrasonic nozzle with a working frequency of 100 kHz). Typically, the size of the orifice is 1 mm. Oftentimes, the median droplet size ranges from 16 to 24 μm, and in certain cases the median size ranges from 18 to 22 μm. A median size of 20 μm is common.

Substrate (25) is typically a spectrally transparent cyclic-olefin copolymer. In certain cases, however, it may be pure poly(norbornene) or a conducting glass plate having an F-doped SnO₂ overlayer.

The temperature of substrate (25) in the apparatus is typically below 400° C. Oftentimes, the temperature is below 350° C. or 325° C. In certain cases, the temperature is below 300° C., 275° C., or even 250° C.

The combination of nanostructured metal oxide and a substrate may be used as a photo-anode in a photoelectrocatalytic cell. Such metal oxide based anodes typically exhibit a maximum incident photon to current conversion efficiency (“IPCE”) of at least 10%, when spectral photoresponses of the anodes are recorded in 0.1 M NaOH_{(aq)}. Oftentimes a maximum IPCE of at least 15% or 20% is exhibited. In certain cases, a maximum IPCE of at least 25%, 30% or 35% is exhibited.

The following are nonlimiting examples of various nanostructured metal oxides of the present invention:

1. Metal oxide film ranging in thickness from 20 nm to 200 nm; at least 10 individual structures on the film surface within a 0.25 μm² area; individual structures with a ratio of long dimension to short being at least 2:1; thickness of individual structures ranging from 0.25 nm to 6 nm; individual structures oriented at an angle between 20° and 160° relative to the film surface plane.

2. Metal oxide film ranging in thickness from 20 nm to 200 nm; at least 25 individual structures on the film surface within a 0.25 μm² area; individual structures with a ratio of long dimension to short being at least 2:1; thickness of individual structures ranging from 0.25 nm to 6 nm; individual structures oriented at an angle between 20° and 160° relative to the film surface plane.

3. Metal oxide film ranging in thickness from 20 nm to 200 nm; at least 50 individual structures on the film surface within a 0.25 μm² area; individual structures with a ratio of long dimension to short being at least 2:1; thickness of individual structures ranging from 0.25 nm to 6 nm; individual structures oriented at an angle between 20° and 160° relative to the film surface plane.

4. Metal oxide film ranging in thickness from 20 nm to 200 nm; at least 75 individual structures on the film surface within a 0.25 μm² area; individual structures with a ratio of long dimension to short being at least 2:1; thickness of individual structures ranging from 0.25 nm to 6 nm; individual structures oriented at an angle between 20° and 160° relative to the film surface plane.

5. Metal oxide film ranging in thickness from 20 nm to 200 nm; at least 100 individual structures on the film surface within a 0.25 μm² area; individual structures with a ratio of long dimension to short being at least 2:1; thickness of individual structures ranging from 0.25 nm to 6 nm; individual structures oriented at an angle between 20° and 160° relative to the film surface plane.

6. Metal oxide film ranging in thickness from 20 nm to 200 nm; at least 10 individual structures on the film surface within a 0.25 μm² area; individual structures with a ratio of long dimension to short being at least 3:1; thickness of individual structures ranging from 0.25 nm to 6 nm; individual structures oriented at an angle between 20° and 160° relative to the film surface plane.

7. Metal oxide film ranging in thickness from 20 nm to 200 nm; at least 10 individual structures on the film surface within a 0.25 μm² area; individual structures with a ratio of long dimension to short being at least 4:1; thickness of individual structures ranging from 0.25 nm to 6 nm; individual structures oriented at an angle between 20° and 160° relative to the film surface plane.

8. Metal oxide film ranging in thickness from 20 nm to 200 nm; at least 10 individual structures on the film surface within a 0.25 μm² area; individual structures with a ratio of long dimension to short being at least 5:1; thickness of disc-like structures ranging from 0.25 nm to 6 nm; individual structures oriented at an angle between 20° and 160° relative to the film surface plane.

9. Metal oxide film ranging in thickness from 20 nm to 200 nm; at least 10 individual structures on the film surface within a 0.25 μm² area; individual structures with a ratio of long dimension to short being at least 6:1; thickness of individual structures ranging from 0.25 nm to 6 nm; individual structures oriented at an angle between 20° and 160° relative to the film surface plane.

10. Metal oxide film ranging in thickness from 20 nm to 200 nm; at least 10 individual structures on the film surface within a 0.25 μm² area; individual structures with a ratio of long dimension to short being at least 2:1; thickness of individual structures ranging from 0.38 nm to 5.5 nm; individual structures oriented at an angle between 20° and 160° relative to the film surface plane.

11. Metal oxide film ranging in thickness from 20 nm to 200 nm; at least 10 individual structures on the film surface within a 0.25 μm² area; individual structures with a ratio of long dimension to short being at least 2:1; thickness of individual structures ranging from 0.5 nm to 5.1 nm; individual structures oriented at an angle between 20° and 160° relative to the film surface plane.

12. Metal oxide film ranging in thickness from 20 nm to 200 nm; at least 10 individual structures on the film surface within a 0.25 μm² area; individual structures with a ratio of long dimension to short being at least 2:1; thickness of individual structures ranging from 0.25 nm to 6 nm; individual structures oriented at an angle between 40° and 140° relative to the film surface plane.

13. Metal oxide film ranging in thickness from 20 nm to 200 nm; at least 10 individual structures on the film surface within a 0.25 μm² area; individual structures with a ratio of long dimension to short being at least 2:1; thickness of individual structures ranging from 0.25 nm to 6 nm; individual structures oriented at an angle between 60° and 120° relative to the film surface plane.

14. Metal oxide film ranging in thickness from 20 nm to 200 nm; at least 10 individual structures on the film surface within a 0.25 μm² area; individual structures with a ratio of long dimension to short being at least 2:1; thickness of individual structures ranging from 0.25 nm to 6 nm; individual structures oriented at an angle of approximately 90° relative to the film surface plane.

15. Metal oxide film ranging in thickness from 20 nm to 200 nm; at least 25 individual structures on the film surface within a 0.25 μm² area; individual structures with a ratio of long dimension to short being at least 3:1; thickness of individual structures ranging from 0.38 nm to 5.5 nm; individual structures oriented at an angle between 40° and 140° relative to the film surface plane.

16. Metal oxide film ranging in thickness from 20 nm to 200 nm; at least 50 individual structures on the film surface within a 0.25 μm² area; individual structures with a ratio of long dimension to short being at least 4:1; thickness of individual structures ranging from 0.38 nm to 5.5 nm; individual structures oriented at an angle between 60° and 120° relative to the film surface plane.

17. Metal oxide film ranging in thickness from 20 nm to 200 nm; at least 75 individual structures on the film surface within a 0.25 μm² area; individual structures with a ratio of long dimension to short being at least 4:1; thickness of individual structures ranging from 0.38 nm to 5.5 nm; individual structures oriented at an angle between 60° and 120° relative to the film surface plane.

18. Metal oxide film ranging in thickness from 20 nm to 200 nm; at least 100 individual structures on the film surface within a 0.25 μm² area; individual structures with a ratio of long dimension to short being at least 4:1; thickness of individual structures ranging from 0.38 nm to 5.5 nm; individual structures oriented at an angle between 60° and 120° relative to the film surface plane.

The following are nonlimiting examples of various method steps one can use to produce nanostructured metal oxides of the present invention:

1. Generation of a micron-sized aerosol of an metal oxide precursor solution; the precursor solution includes a metal-based organometallic at a concentration ranging from 0.001M to 0.02M in either an organic alcohol or ether; directing the aerosol to a heated substrate; the substrate is either a: a) spectrally transparent glass with a conductive overlayer, or, b) spectrally transparent cyclic-olefin copolymer or a pure poly(norbornene); the substrate temperature is below 400° C.; allowing the metal oxide precursor to pyrolyze on the substrate surface to produce the nanostructured metal oxide.

2. Generation of a micron-sized aerosol of a metal oxide precursor solution; the precursor solution includes a metal-based organometallic at a concentration ranging from 0.003M to 0.015M in either an organic alcohol or ether; directing the aerosol to a heated substrate; the substrate is either a: a) spectrally transparent glass with a conductive overlayer, or, b) spectrally transparent cyclic-olefin copolymer or a pure poly(norbornene); the substrate temperature is below 400° C.; allowing the metal oxide precursor to pyrolyze on the substrate surface to produce the nanostructured metal oxide.

3. Generation of a micron-sized aerosol of an metal oxide precursor solution; the precursor solution includes a metal-based organometallic at a concentration ranging from 0.005M to 0.011M in either an organic alcohol or ether; directing the aerosol to a heated substrate; the substrate is either: a) spectrally transparent glass with a conductive overlayer, or, b) a spectrally transparent cyclic-olefin copolymer or a pure poly(norbornene); the substrate temperature is below 400° C.; allowing the metal oxide precursor to pyrolyze on the substrate surface to produce the nanostructured metal oxide.

4. Generation of a micron-sized aerosol of a metal oxide precursor solution; the precursor solution includes a metal-based organometallic at a concentration ranging from 0.001M to 0.02M in 200 proof ethanol; directing the aerosol to a heated substrate; the substrate is either a: a) spectrally transparent glass with a conductive overlayer, or, b) spectrally transparent cyclic-olefin copolymer or a pure poly(norbornene); the substrate temperature is below 400° C.; allowing the metal oxide precursor to pyrolyze on the substrate surface to produce the nanostructured metal oxide.

5. Generation of a micron-sized aerosol of a metal oxide precursor solution; the precursor solution includes a metal-based organometallic at a concentration ranging from 0.001M to 0.02M in t-butanol; directing the aerosol to a heated substrate; the substrate is either a: a) spectrally transparent glass with a conductive overlayer, or, b) spectrally transparent cyclic-olefin copolymer or a pure poly(norbornene); the substrate temperature is below 400° C.; allowing the metal oxide precursor to pyrolyze on the substrate surface to produce the nanostructured metal-oxide.

6. Generation of a micron-sized aerosol of a metal oxide precursor solution; the precursor solution includes a metal-based organometallic at a concentration ranging from 0.001M to 0.02M in tetrahydrofuran; directing the aerosol to a heated substrate; the substrate is either a: a) spectrally transparent glass with a conductive overlayer, or, b) spectrally transparent cyclic-olefin copolymer or a pure poly(norbornene); the substrate temperature is below 400° C.; allowing the metal oxide precursor to pyrolyze on the substrate surface to produce the nanostructured metal oxide.

7. Generation of a micron-sized aerosol of a metal oxide precursor solution; the precursor solution includes a metal-based organometallic at a concentration ranging from 0.001M to 0.02M in either an organic alcohol or ether; directing the aerosol to a heated substrate; the substrate is either a: a) spectrally transparent glass with a conductive overlayer, or, b) spectrally transparent cyclic-olefin copolymer or a pure poly(norbornene); the substrate temperature is below 350° C.; allowing the metal oxide precursor to pyrolyze on the substrate surface to produce the nanostructured metal oxide.

8. Generation of a micron-sized aerosol of a metal oxide precursor solution; the precursor solution includes a metal-based organometallic at a concentration ranging from 0.001M to 0.02M in either an organic alcohol or ether; directing the aerosol to a heated substrate; the substrate is either a: a) spectrally transparent glass with a conductive overlayer, or, b) spectrally transparent cyclic-olefin copolymer or a pure poly(norbornene); the substrate temperature is below 325° C.; allowing the metal oxide precursor to pyrolyze on the substrate surface to produce the nanostructured metal oxide.

9. Generation of a micron-sized aerosol of a metal oxide precursor solution; the precursor solution includes a metal-based organometallic at a concentration ranging from 0.001M to 0.02M in either an organic alcohol or ether; directing the aerosol to a heated substrate; the substrate is either a: a) spectrally transparent glass with a conductive overlayer, or, b) spectrally transparent cyclic-olefin copolymer or a pure poly(norbornene); the substrate temperature is below 300° C.; allowing the metal oxide precursor to pyrolyze on the substrate surface to produce the nanostructured metal oxide.

10. Generation of a micron-sized aerosol of an metal oxide precursor solution; the precursor solution includes a metal-based organometallic at a concentration ranging from 0.001M to 0.02M in either an organic alcohol or ether; directing the aerosol to a heated substrate; the substrate is either a: a) spectrally transparent glass with a conductive overlayer, or, b) spectrally transparent cyclic-olefin copolymer or a pure poly(norbornene); the substrate temperature is below 275° C.; allowing the metal oxide precursor to pyrolyze on the substrate surface to produce the nanostructured metal oxide.

11. Generation of a micron-sized aerosol of a metal oxide precursor solution; the precursor solution includes an metal-based organometallic at a concentration ranging from 0.001M to 0.02M in either an organic alcohol or ether; directing the aerosol to a heated substrate; the substrate is either a: a) spectrally transparent glass with a conductive overlayer, or, b) spectrally transparent cyclic-olefin copolymer or a pure poly(norbornene); the substrate temperature is below 250° C.; allowing the metal oxide precursor to pyrolyze on the substrate surface to produce the nanostructured metal oxide.

The following are nonlimiting examples of photo-anodes constructed from nanostructured metal oxides of the present invention:

1. Combination of substrate and metal oxide film; substrate is either a: a) spectrally transparent glass with a conductive overlayer, or, b) spectrally transparent cyclic-olefin copolymer or pure poly(norbornene); metal oxide film ranging in thickness from 20 nm to 200 nm; at least 10 individual structures on the film surface within a 0.25 μm² area; individual structures with a ratio of long dimension to short being at least 2:1; thickness of individual structures ranging from 0.25 nm to 6 nm; individual structures oriented at an angle between 20° and 160° relative to the film surface plane.

2. Combination of substrate and metal oxide film; substrate is either a: a) spectrally transparent glass with a conductive overlayer, or, b) spectrally transparent cyclic-olefin copolymer or pure poly(norbornene); at least 25 individual structures on the film surface within a 0.25 μm² area; individual structures with a ratio of long dimension to short being at least 3:1; thickness of individual structures ranging from 0.25 nm to 6 nm; individual structures oriented at an angle between 40° and 140° relative to the film surface plane.

3. Combination of substrate and metal oxide film; substrate is a spectrally transparent cyclic-olefin copolymer; metal oxide film ranging in thickness from 20 nm to 200 nm; at least 25 individual structures on the film surface within a 0.25 μm² area; individual structures with a ratio of long dimension to short being at least 3:1; thickness of individual structures ranging from 0.25 nm to 6 nm; individual structures oriented at an angle between 60 and 120° relative to the film surface plane.

4. Combination of substrate and metal oxide film; substrate is a spectrally transparent cyclic-olefin copolymer; metal oxide film ranging in thickness from 20 nm to 200 nm; at least 50 individual structures on the film surface within a 0.25 μm² area; individual structures with a ratio of long dimension to short being at least 3:1; thickness of individual structures ranging from 0.25 nm to 6 nm; individual structures oriented at an angle between 60° and 120° relative to the film surface plane.

5. Combination of substrate and metal oxide film; substrate is a spectrally transparent cyclic-olefin copolymer; metal oxide film ranging in thickness from 20 nm to 200 nm; at least 50 individual structures on the film surface within a 0.25 μm² area; individual structures with a ratio of long dimension to short being at least 3:1; thickness of individual structures ranging from 0.25 nm to 6 nm; individual structures oriented at an angle between 60° and 120° relative to the film surface plane; IPCE of at least 15%.

6. Combination of substrate and metal oxide film; substrate is a spectrally transparent cyclic-olefin copolymer; metal oxide film ranging in thickness from 20 nm to 200 nm; at least 50 individual structures on the film surface within a 0.25 μm² area; individual structures with a ratio of long dimension to short being at least 3:1; thickness of individual structures ranging from 0.25 nm to 6 nm; individual structures oriented at an angle between 60° and 120° relative to the film surface plane; IPCE of at least 20%.

7. Combination of substrate and metal oxide film; substrate is a spectrally transparent cyclic-olefin copolymer; metal oxide film ranging in thickness from 20 nm to 200 nm; at least 50 individual structures on the film surface within a 0.25 μm² area; individual structures with a ratio of long dimension to short being at least 3:1; thickness of individual structures ranging from 0.25 nm to 6 nm; individual structures oriented at an angle between 60° and 120° relative to the film surface plane; IPCE of at least 25%.

8. Combination of substrate and metal oxide film; substrate is a spectrally transparent cyclic-olefin copolymer; metal oxide film ranging in thickness from 20 nm to 200 nm; at least 50 individual structures on the film surface within a 0.25 μm² area; individual structures with a ratio of long dimension to short being at least 3:1; thickness of individual structures ranging from 0.25 nm to 6 nm; individual structures oriented at an angle between 60° and 120° relative to the film surface plane; IPCE of at least 30%.

1. A metal oxide film, wherein the film ranges in thickness from 20 nm to 200 nm, wherein there are at least 10 individual structures on the film surface within a 0.25 μm² area, and wherein the individual structures have a ratio of long dimension to short being of least 2:1, and wherein the thickness of the disc-like structures ranges from 0.25 nm to 6 nm, and wherein the individual structures are oriented at an angle between 20° and 160° relative to the film surface plane.

2. The metal oxide film according to claim 1, wherein there are at least 25 individual structures on the film surface within a 0.25 μm² area.

3. The metal oxide film according to claim 1, wherein the individual structures are oriented at an angle between 40° and 140° relative to the film surface plane.

4. The metal oxide film according to claim 2, wherein there are at least 50 individual structures on the film surface within a 0.25 μm² area.

5. The metal oxide film according to claim 4, wherein the individual structures are oriented at an angle between 40° and 140° relative to the film surface plane.

6. A method of producing an metal oxide film, wherein the method comprises the steps of:
a) generating a micron-sized aerosol of a metal oxide precursor solution, wherein the precursor solution comprises a metal-based organometallic at a concentration ranging from 0.001M to 0.02 M in either an organic alcohol or ether;
b) directing the aerosol to a heated substrate, wherein the substrate is either a spectrally transparent cyclic-olefin copolymer or poly(norbornene), and wherein the substrate temperature is less than 400° C.; and,
c) allowing the metal oxide precursor to pyrolyze on the substrate surface thereby forming the metal oxide film, wherein there are at least 10 individual structures on the film surface within a 0.25 μm² area.

7. The method according to claim 6, wherein the precursor solution comprises 200 proof ethanol.

8. The method according to claim 6, wherein the substrate temperature is less than 350° C.

9. The method according to claim 8, wherein the substrate temperature is less than 300° C.

10. A photo-anode, wherein the photo-anode comprises:
a) a substrate, wherein the substrate is either a: a) spectrally transparent glass with a conductive overlayer, or, b) spectrally transparent cyclic-olefin copolymer or poly(norbornene); and,
b) a metal oxide film, wherein the film ranges in thickness from 20 nm to 200 nm, and wherein at least 10 individual structures are on the surface of the film within a 25 μm² area, and wherein the individual structures have a ratio of long dimension to short dimension of at least 2:1, and wherein the thickness of the individual structures ranges from 0.25 nm to 6 nm, and wherein the individual structures are oriented at an angle between 20° and 160° relative to the film surface plane.

11. The photo-anode according to claim 10, wherein the substrate is a spectrally transparent cyclic-olefin copolymer.

12. The photo-anode according to claim 11, wherein at least 25 individual structures are on the surface of the film within a 25 μm² area.
